(19) United States
(12) Patent Application Publication
(10) Pub. No.: US 2011/0138121 A1
(43) Pub. Date: Jun. 9, 2011

(54) Card Reader

(76) Inventors: Chih-Kuei Hu, Jubei (TW); Wei-Ting Liu, Hacienda Height, CA (US); Wei-Hua Lu, Taipei (TW)

(21) Appl. No.: 12/633,796

(22) Filed: Dec. 9, 2009

(51) Int. Cl. G06F 12/00

(52) U.S. Cl. 711/115; 711/E12.001

(57) ABSTRACT

The present invention discloses a card reader comprising a plurality of card slots for inserting the memory cards, and a circuit for integrating storage space of the memory cards into an integrated storage medium. The integrated storage medium is used as one external disk.

### BACKGROUND OF THE INVENTION

1. Field of the Invention

The present invention relates to a card reader, and more particularly, to a card reader being capable of integrating storage space of different memory cards into an integrated storage space.

2. Description of the Prior Art

Memory card is popularly used in various electronic devices, such as digital camera, smart phone and PDA. If user wants to access the data stored in the memory card from the computer, the general way is using the card reader. The conventional card reader has at least one card slot for inserting memory cards. The card reader can be connected to a computer for user to access the memory card via the card reader, and each memory card has fixed storage space. Since the storage space of memory card is fixed, size of the file stored in the memory card must be equal to or smaller than the storage space of memory card.

The conventional card reader restricts the file size stored in the memory card. A card reader usually has several card slots, and several memory cards can be used at the same time. With the restriction of file size, the stored file must small than the storage space of the designated memory card. If user needs to store a large file in the memory card, he must replace a new memory card having larger storage space.

### SUMMARY OF THE INVENTION

It is therefore an objective of the present invention to provide a card reader being capable of integrating storage space of different memory cards into an integrated storage space.

The present invention utilizes at least two memory cards to compose a storage medium for storing a file having file size larger than any of the memory cards.

The present invention discloses a card reader comprising a plurality of card slots for placing the memory cards, and a circuit for integrating storage space of the memory cards into an integrated storage medium. The integrated storage medium is used as one external disk.

The present invention also discloses an electronic system comprising a card reader and a host. The card reader has a plurality of card slots for placing the memory cards, and the host is coupled to the card reader for executing integration software to integrate storage spaces of the memory cards into an integrated storage medium.

The present invention further discloses a card reader comprising a first slot for placing a first memory card, the first memory card having a first memory space; and a second slot for placing a second memory card, the second memory card having a second memory space. The first and the second memory space are integrated into a third memory space, the third memory space is larger than the first memory space, and third memory space is larger than the second memory space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a card reader according to the first embodiment of the present invention.

FIG. 2 shows a card reader according to the second embodiment of the present invention.

FIG. 3 shows a card reader according to the third embodiment of the present invention.

### DETAILED DESCRIPTION

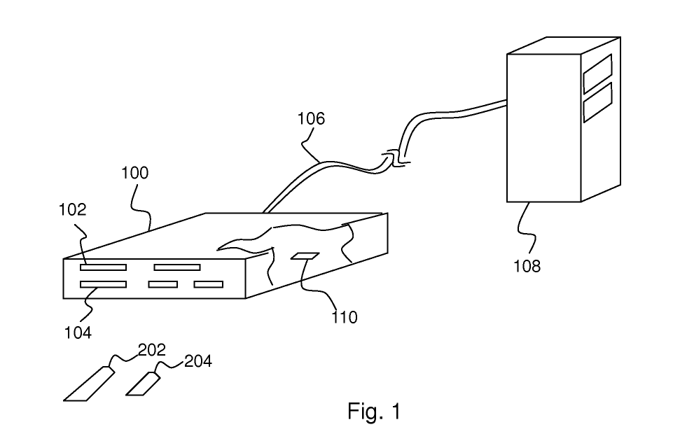

Please refer to FIG. 1, which discloses a card reader according to an embodiment of the present invention. The card reader 100 includes the card slots 102 and 104, and the control circuit 110. The card slots 102 and 104 are used for placing the memory cards 202 and 204, and the memory cards 202 and 204 can be same or different types of memory cards. The card reader 100 is coupled to a computer 108 via an electric cable 106, and the computer 108 can read or write data stored in the memory cards 202 and 204 via the card reader 100.

The card reader 100 can be coupled to the computer 108 via the electric cable 106 using any compatible interface, such as USB, mini USB, IEEE 1394, IDE, SATA, STAT II, PCMCIA or PCI interface and so on, to read or write data. Furthermore, the electric cable 106 can be also omitted, and the card reader 100 is directly plugged onto the computer 108 via a plug interface.

The control circuit 110 is used for integrating the storage space of the memory cards 202 and 204 into an integrated memory space, and the computer 108 can use the integrated memory space as one external disk. For example, the storage space of the memory card 202 is 100 MB, and the storage space of the memory card 204 is 150 MB. The control circuit 110 can integrate the storage space of the memory cards 202 and 204 into 250 MB, and the computer 108 can access the integrated memory space as an external disk to write a file having 230 MB file size.

One embodiment to achieve the integration of the storage space of memory cards 202 and 204 could be file division, which is arranged and controlled by the control circuit 110. When the computer needs to store a file in the integrated memory space, the control circuit 110 can build a data table according the storage space of the memory cards 202 and 204 and the file size. Then, the file is divided into small portions by the control circuit 110 before written to the memory cards 202 and 204, and is combined to a single file by the control circuit 110 after read from the memory cards 202 and 204. Therefore, the computer can treat the integrated memory space as one single external disk, and the storage space of the external disk is larger than the storage space of each of the memory cards 202 or 204.

Another embodiment to achieve the integration of the storage space of memory cards 202 and 204 could be building a mapping table corresponding to the file and the storage space of memory cards 202 and 204. The mapping table is used for storing the information of the physical and logical position of the memory cards 202 and 204. When the file is written to the integrated storage space, the control circuit 110 can refer to the mapping table and write the file to the memory cards 202 and 204 as one single disk.

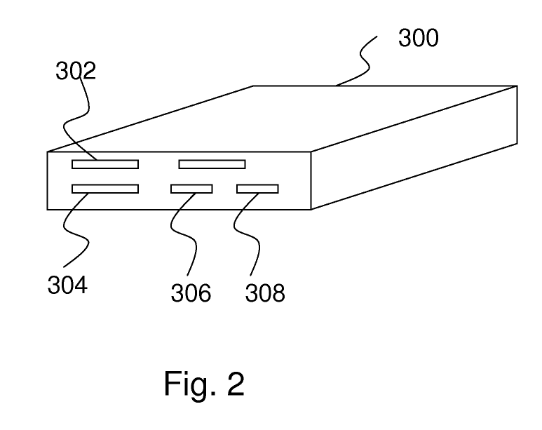

Please refer to FIG. 2, which discloses a card reader according to the second embodiment of the present invention. In FIG. 2, the card reader 300 comprises card slots 302, 304, 306 and 308. The card slots 302 and 304 are used for placing memory cards and accomplishing the integrated external disk function as disclosed in the first embodiment. The card slots 306 and 308 are used as the conventional card slots to read and write single memory card. The card reader 300 provides an integrated storage space composed of memory cards in card slots 302 and 304, and at least one card slot without integration function.

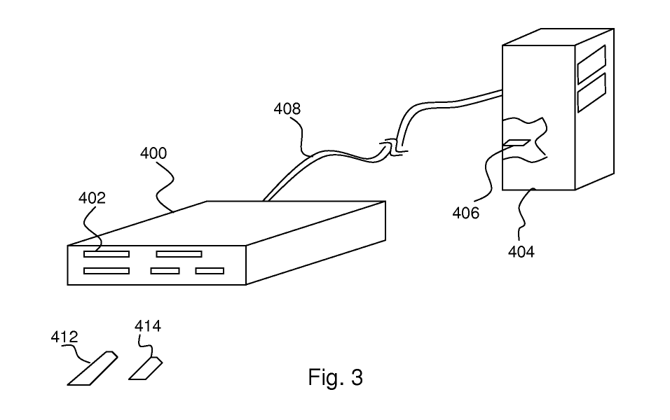

Please refer to FIG. 3, which discloses a card reader according to the third embodiment of the present invention. The card reader 400 is coupled to the computer 404 via an electric cable 408. The card reader comprises a plurality of card slots 402 for placing memory cards 412 and 414. The computer 404 comprises a control circuit 406, and the control circuit 406 is used for integrating the storage space of the memory cards 412 and 414 into an integrated memory space. The computer 404 can use the integrated memory space as one external disk. For example, the storage space of the memory card 412 is 100 MB, and the storage space of the memory card 414 is 150 MB. The control circuit 406 can integrate the storage space of the memory cards 412 and 414 into 250 MB, and the computer 404 can access the integrated memory space as an external disk to write a file having 230 MB file size. The function of the control circuit 406 achieving the integration of the storage space is similar to the control circuit 110 described in the first embodiment. When the computer 404 needs to store a file in the integrated memory space, the control circuit 406 can build a data table according the storage space of the memory cards 412 and 414 and the file size. Then, the file is divided into small portions by the control circuit 406 before written to the memory cards 412 and 414, and is combined to a single file by the control circuit 406 after read from the memory cards 412 and 414. Therefore, the computer 404 can treat the integrated memory space as one single external disk, and the storage space of the external disk is larger than the storage space of the memory cards 412 or 414.

The present invention can further comprise a card removal confirmation mechanism. When the user wants to remove the memory cards from the card reader, the control circuit can trigger a warning function to remind the user. This warning function can avoid damaging the data stored in the integrated storage space. The user should confirm the removal activity, or further press a confirmation key to remove the memory cards from the card slots. The present invention can further comprise a file movement function for user to move partial file before remove one of the memory cards from the card reader. For example, if three memory cards are inserted and used in the card reader, the control circuit can provide a function to move partial file stored in one memory card to the other two memory cards, and then the cleared memory card can be removed or replaced.

Furthermore, the present invention can be also achieved by a software system. The software system can be executed in the computer or host to integrate the storage space of the memory cards. Before the file is written into the memory cards, the software system can use the division or mapping table methods to disperse the file to different memory cards. And after the file is read from the different memory cards, the software system can merge them into one single file.

Those skilled in the art will readily observe that numerous modifications and alterations of the device and method may be made while retaining the teachings of the invention.

What is claimed is:

1. A card reader comprising:
a first set of card slots for placing a first set of memory cards; and
a circuit for integrating storage space of the first set of memory cards into an integrated storage medium;
wherein the integrated storage medium is used as one external disk.

2. The card reader of claim 1, wherein the first set of memory cards are capable of being different types of memory cards.

3. The card reader of claim 1, wherein the circuit have a warning function acted when any of the first set of memory cards is to be pulled out the first set of card slots.

4. The card reader of claim 3, wherein the warning function comprises a confirmation step for user to confirm the pull-out action.

5. The card reader of claim 1 further comprising a second set of card slots for placing a second set of memory cards, wherein the second set of memory cards are capable of being accessed independently.

6. The card reader of claim 1, wherein the integrated storage medium is capable of being stored a file having a first file size, wherein the first file size is larger than storage space of each of the first set of memory cards.

7. An electronic system comprising:
a card reader, having a first set of card slots for placing a first set of memory cards; and
a host, coupled to the card reader, for executing an integration software to integrate storage spaces of the first set of memory cards into an integrated storage medium.

8. The electronic system of claim 7, wherein the first set of memory cards are capable of being different types of memory cards.

9. The electronic system of claim 7, wherein the integration software have a warning function acted when any of the first set of memory cards is to be pulled out the first set of card slots.

10. The electronic system of claim 9, wherein the warning function comprises a confirmation step for user to confirm the pull-out action.

11. The electronic system of claim 7 further comprising a second set of card slots for placing a second set of memory cards, wherein the second set of memory cards are capable of being accessed by the host independently.

12. The electronic system of claim 7, wherein the integrated storage medium is capable of being stored a file having a first file size, wherein the first file size is larger than storage space of each of the first set of memory cards.

13. A card reader, comprising:
a first slot for placing a first memory card, the first memory card having a first memory space; and
a second slot for placing a second memory card, the second memory card having a second memory space;
wherein the first and the second memory space are integrated into a third memory space, the third memory space is larger than the first memory space, and third memory space is larger than the second memory space.

14. The card reader of claim 13 further comprising an integrating circuit for integrating the first and the second memory space into the third memory space.

15. The card reader of claim 14, wherein the integrating circuit have a warning function acted when the first memory cards is to be pulled out the first slot.

16. The card reader of claim 15, wherein the warning function comprises a confirmation step for user to confirm the pull-out action.

17. The card reader of claim 13, wherein the first and the second memory space are integrated into the third memory space by an integration software.

18. The card reader of claim 17, wherein the integration software have a warning function acted when the first memory cards is to be pulled out the first slot.

19. The card reader of claim 18, wherein the warning function comprises a confirmation step for user to confirm the pull-out action.
